(19) United States
(12) Patent Application Publication
(10) Pub. No.: US 2009/0040318 A1
(43) Pub. Date: Feb. 12, 2009

(54) IMAGE STABILIZATION WITH USER FEEDBACK

(76) Inventors: Michael John Brosnan, Fremont, CA (US); Robert A. Black, Milpitas, CA (US); Alexander Schneider, Los Altos, CA (US)

Correspondence Address: Kathy Manke;Avago Technologies Limited, 4380 Ziegler Road, Fort Collins, CO, 80525, US

(21) Appl. No.: 11/836,478

(22) Filed: Aug. 9, 2007

(51) Int. Cl. H04N 5/228

(52) U.S. Cl. 348/208.4

(57) ABSTRACT

An apparatus to facilitate image stabilization with user feedback is described. An embodiment of the apparatus includes an image sensor, a movement detector, and a digital processor. The image sensor acquires an image of a scene over an exposure period. The movement detector is coupled to the image sensor. The movement detector computes a movement measurement of the image sensor during the exposure period. The digital processor is coupled to the movement detector. The digital processor provides feedback to a user during the exposure period. The feedback is based on the movement measurement. Embodiments of the apparatus provide a simpler and less costly implementation for image stabilization.

### BACKGROUND OF THE INVENTION

Image blur is a common problem in photography and has a variety of causes such as focusing errors and motion of the imaged object. Motion of the camera relative to the imaged object is another source of image blur. Camera motion is also referred to as camera shake or hand shudder. When a person is holding a camera during exposure, camera shake causes image blurring, particularly during long exposure times and for image enlargement (e.g., using a zoom or telephoto lens). Camera shake is typical because human muscles naturally tremor at frequencies approximately in the range of 4-12 Hz. Long exposure times (e.g., approximately one second or more) aggravate this problem. For example, an untrained user using a camera without a viewfinder may exhibit about six degrees of angular movement during an exposure time of about one second. Additionally, small cameras such as cell phone cameras are particularly prone to camera shake because they are constructed of lightweight materials and are sometimes awkward to hold during operation.

In efforts to reduce image blur, imaging devices such as hand-held cameras typically implement some type of image stabilization technology. Image stabilization refers to reducing the effects of relative movement between an image sensor and an object being imaged. Conventional image stabilization techniques for still camera systems, as compared to video camera systems, typically involve movement measurements and complementary mechanical displacement of a lens or image sensor. Conventional camera systems typically use two or more gyroscopes (e.g., piezoelectric or microelectromechanical systems (MEMS) gyros) to measure the movement of the camera. Once the movement is measured, mechanical displacement systems physically move the image sensor in a manner to compensate for the movement of the camera. Other conventional systems physically move the camera lens to compensate for the detected camera movement. However these conventional mechanical systems are cost prohibitive and are often too large to be implemented in small camera systems such as cell phone cameras. Also, the use of gyros is not suitable for measuring slow hand movements during long exposure times because gyros do not have a direct current (DC) frequency response. Additionally, conventional mechanical systems are subject to mechanical failures.

In addition to compensating for camera shake during the exposure period, another way to reduce the effects of camera shake is to stabilize the camera during the exposure period. For example, using a tripod helps to reduce camera movement. Similarly, trained photographers often use known techniques (e.g., holding the camera steady against the photographer's body or another object, reducing breathing during the exposure period, etc.). Thus, reducing the causes of camera movement also reduces the blurriness of the resulting image.

### SUMMARY OF THE INVENTION

Embodiments of an apparatus are described. In one embodiment, the apparatus is an apparatus to facilitate image stabilization with user feedback. In one embodiment, the apparatus includes an image sensor, a movement detector, and a digital processor. The image sensor acquires an image of a scene over an exposure period. The movement detector is coupled to the image sensor. The movement detector computes a movement measurement of the image sensor during the exposure period. The digital processor is coupled to the movement detector. The digital processor provides feedback to a user during the exposure period. The feedback is based on the movement measurement. Embodiments of the apparatus provide a simpler and less costly implementation for image stabilization. Other embodiments of the apparatus are also described.

Embodiments of a method are also described. In one embodiment, the method is a method for image stabilization. An embodiment of the method includes generating an image of a scene over an exposure period, computing a movement measurement of an image sensor during the exposure period, and providing feedback to a user during the exposure period. The feedback is indicative of a magnitude of the movement measurement. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a camera system.

FIG. 2A depicts a schematic diagram of one embodiment of camera display with visual feedback to communicate angular movement of the camera system to a user using a target marker and crosshair marker superimposed on an image.

FIG. 2B depicts a schematic diagram of another embodiment of the camera display of FIG. 2A.

FIG. 3 depicts a schematic diagram of another embodiment of a camera display with visual feedback to communicate angular movement of the camera system to a user using an updated image position relative to an original image position.

FIG. 4A depicts a schematic diagram of another embodiment of a camera display with visual feedback to communicate angular movement of the camera system to a user using a cropped portion of an image.

FIG. 4B depicts a schematic diagram of another embodiment of a camera display with visual feedback to communicate angular movement of the camera system to a user using a cropped portion of an image.

FIG. 5 depicts a schematic diagram of another embodiment of a camera display with visual feedback to communicate angular movement of the camera system to a user using a magnified portion of an image.

FIG. 6 depicts a schematic diagram of another embodiment of a camera system with audio feedback to communicate angular movement of the camera system to a user using an audio signal.

FIG. 7 depicts a schematic flow chart diagram of one embodiment of a method for image stabilization with user feedback.

FIG. 8 depicts a schematic flow chart diagram of one embodiment of a method for providing visual feedback to a user.

FIG. 9 depicts a schematic flow chart diagram of one embodiment of a method for providing audio feedback to a user.

Throughout the description, similar reference numbers may be used to identify similar elements.

### DETAILED DESCRIPTION

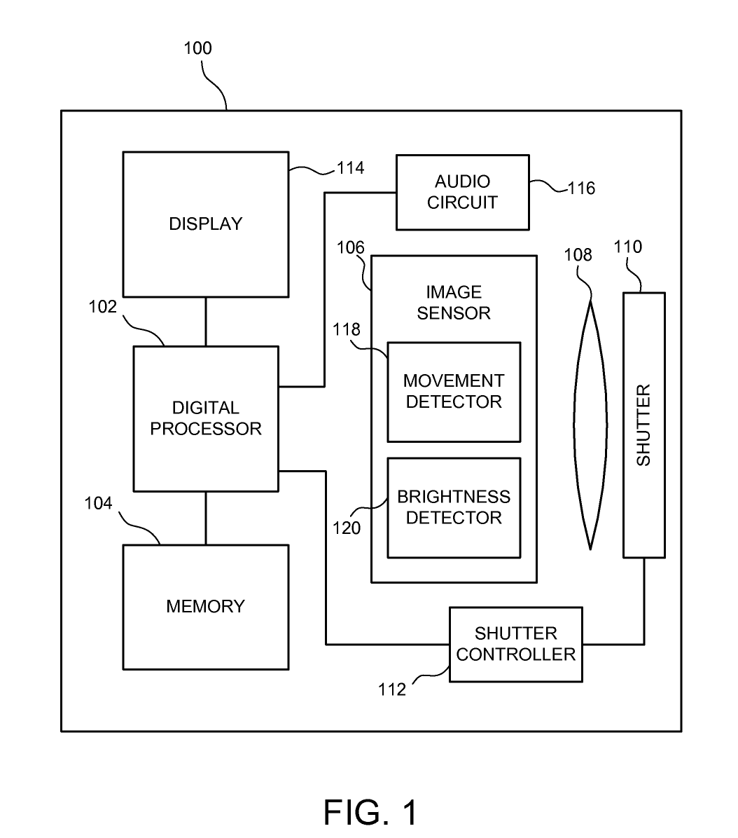

FIG. 1 depicts a schematic diagram of one embodiment of a camera system 100. The depicted camera system 100 includes a digital processor 102, an electronic memory device 104, an image sensor 106, a lens 108, a shutter 110, a shutter controller 112, a display device 114, and an audio circuit 116. Although the various elements of the camera system 100 are shown in a particular arrangement, it should be noted that the depicted configuration is merely schematic and other embodiments may implement arrangements that are different from what is shown in FIG. 1. Additionally, some embodiments of the camera system 100 may include fewer or more elements than are shown in FIG. 1 and described below. For example, some embodiments may exclude the audio circuit 116.

In one embodiment, the digital processor 102 facilitates execution of various instructions and operations which impart functionality to the camera system 100. These instructions may be stored within the digital processor 102, in the memory 104, or in another memory device within or coupled to the camera system 100. The memory 104 also stores images and other data used in connection with the various operations of the camera system 100.

In one embodiment, the image sensor 106 acquires an image of a scene over an exposure period. In other words, the image sensor 106 generates image data to represent an imaged object (not shown). The image sensor 106 may implement one or more sensor technologies such as charge-coupled device (CCD) technology, complementary metal-oxide-semiconductor (CMOS) technology, or another sensor technology. Typical implementations of these imaging technologies are known and are not described in more detail herein.

The depicted image sensor 106 includes a movement detector 118 and a brightness detector 120. Although the movement detector 118 and the brightness detector 120 are schematically shown within the image sensor 106, different embodiments of the image sensor 106 and the camera system 100 may use various types of movement detectors 118 and brightness detectors 120. For example, the movement detector 118 may be one or more piezoelectric or MEMS gyros. Alternatively, the movement detector 118 may be implemented using imaging technology, instead of gyros. Examples of motion detection using imaging technology are provided in U.S. Patent Publication No. 2006/0131485 to Rosner et al. and U.S. Patent Publication No. 2007/0046782 to Helbing et al.

In one embodiment, the movement detector 118 generates movement measurement information to determine if the image sensor 106 moves relative to the imaged object during an exposure period. In other words, the movement detector 118 is configured to generate the movement measurement information based on image data from the image sensor 106. In another embodiment, the movement detector 118 computes a movement measurement indicative of movement of the image sensor from an original heading during the exposure period. Additionally, the movement detector 118 may constantly or periodically monitor the position of the image sensor 106 during the exposure period.

Although referred to as movement measurement information, the movement measurement information may or may not include actual measurement data. In one embodiment, the movement measurement information is a number or set of numbers indicative of the direction and/or magnitude (i.e., displacement) of the image sensor 106 relative to the imaged object. Some embodiments of the movement detector 118 calculate angular movement of the camera 100 in pitch and yaw during image exposure in order to generate the movement measurement information. Additional details of embodiments of the movement detector 118 are described below.

In one embodiment, the image sensor 106 receives incident light via the optical lens 108 and/or the shutter 110. The optical lens 108 directs and focuses the light on the image sensor 106. In general, the shutter 110 regulates the time that the image sensor 106 is responsive to light incident on the image sensor 106. In some embodiments, the shutter 110 is a physical shutter that opens and closes to block light from the image sensor 106. In other embodiments, the shutter 110 is an electronic shutter that regulates the time the image sensor 106 is responsive to incident light. It should be noted that there are many types of shutters 110 and optical lenses 108 (or compound lenses), and embodiments of the camera system 100 may use any combination of shutters 110 and/or lenses 108.

In one embodiment, the shutter controller 112 controls the operations of the shutter 110. For a physical shutter 110, the shutter controller 112 controls when the shutter 110 opens and closes. For an electronic shutter 110, the shutter controller 112 controls how long the image sensor 106 is responsive to incident light. The amount of light incident on the image sensor 106 is at least partially dependent on the amount of time the shutter 110 is open or the image sensor 106 is responsive to light. Allowing too much light through the shutter 110, or allowing the image sensor 106 to be responsive for too long, results in overexposure of the image, or an image that is too bright. Closing the shutter 110 before sufficient light has reached the image sensor 106, or activating the image sensor 106 for too short of a time, results in underexposure, or an image that is too dark. In one embodiment, the brightness detector 120 generates brightness information to determine the brightness of the resulting image. Additional details of embodiments of the brightness detector 120 are described below.

Additionally, movement of the camera system 100, including the image sensor 106, during exposure of the image sensor 106 to the incident light can cause image blur in the final image, which may be displayed on the display device 114. In some embodiments, the digital processor 102 is configured to provide feedback to a user during the exposure period so that the user may adjust the heading of the camera 100 to limit the movement of the image sensor 106 during the exposure period. This type of feedback may help a user to limit the amount of blurriness in the resulting image, especially for a still picture camera of, for example, a mobile computing device. However, this type of feedback may be useful in many different types of still and motion picture cameras.

In one embodiment, the feedback is visual feedback for display on the display device 114 coupled to the digital processor 102. The display device 114 may be a liquid crystal display (LCD) or another type of display device. Alternatively, the visual feedback may be communicated to the user via another visual feedback device such as a light emitting diode (LED). Exemplary visual feedback implementations are described below with reference to the following figures.

In another embodiment, the feedback is audio feedback for communication to a user via the audio circuit 116 coupled to the digital processor 102. The audio circuit 116 may include a digital-to-analog converter (DAC), a speaker, and other hardware and/or software components. Exemplary audio feedback implementations are described below with reference to the following figures. In some embodiments, the camera system 100 may provide a combination of visual and audio feedback.

It should also be noted that the feedback may be provided at different times during the exposure period. In one embodiment, the feedback is provided essentially continuously during the exposure period, regardless of the magnitude of the movement measurement. In another embodiment, the feedback is only provided when the magnitude of the movement measurement exceeds a threshold value. For example, the audio feedback may be provided when the magnitude of the movement measurement indicates that the angular movement is large enough to cause noticeable blurriness in the resulting image (e.g., 0.03 degrees for a 3 megapixel camera).

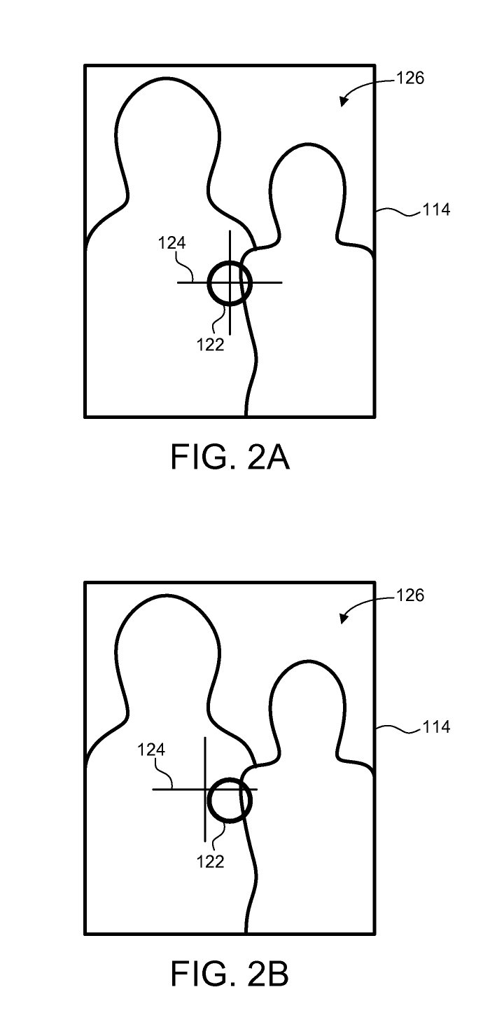

FIG. 2A depicts a schematic diagram of one embodiment of camera display 114 with visual feedback to communicate angular movement of the camera system 100 to a user using a target marker 122 and a crosshair marker 124 superimposed on an image 126. It should be noted that the specific shapes depicted in the figures to represent the target marker 122 and the crosshair marker 124 are merely representative of first and second visual markers that may be used. In other embodiments, other shapes of markers may be used. For example, the target marker 122 and the crosshair marker 124 may both be the same shape with the same or different sizes. Other embodiments may depict one or both markers with other shapes, alphanumeric characters, symbols, pictures, and so forth. Additionally, some embodiments may use more than two markers. For example, some embodiments use a pair of lines for vertical movement and a separate pair of lines for horizontal movement. Thus, embodiments may use different quantities and/or graphical representations of the target marker 122 and the crosshair marker 124.

In one embodiment, a first visual marker (e.g., the target marker 122 depicted with a circle) is located at a fixed location on the display device 114. The fixed location corresponds to an original heading of the image sensor 106. A second visual marker (e.g., the crosshair marker 124 depicted with intersecting lines) is moveable on the display device 114 relative to the first visual marker 122 according to the movement measurement computed by the movement detector 118. In other words, the target marker 122 remains in the same place to show where the camera 100 is originally pointing, for example, at the beginning of the exposure period. In contrast, the crosshair marker 124 moves on the display device 114 to show how the camera 100 is moving during the exposure period. As described above, the movement measurement information is provided by the movement detector 118.

FIG. 2B depicts a schematic diagram of another embodiment of the camera display 114 of FIG. 2A. In the illustrated embodiment, the crosshair marker 124 is shown moved from its position in FIG. 2A to convey that the heading of the camera 100 is different from the initial heading at the beginning of the exposure period. Alternatively, the crosshair marker 124 may remain in a fixed location and the target marker 122 may move on the display device 114. In either case, the difference between the locations of the target marker 122 and the crosshair marker 124 is representative of the magnitude and/or the direction of the deviation of the image sensor 106 from its original heading at the beginning of the exposure period. Additionally, it should be noted that the target marker 122 and the crosshair marker 124 may be shown on the display device 114 even though an image 126 is not displayed on the display device 114.

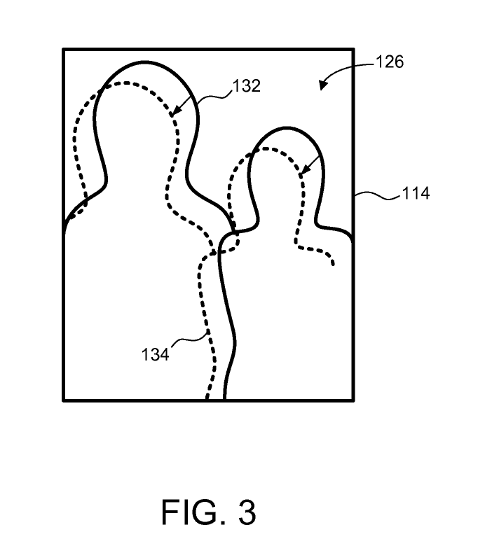

FIG. 3 depicts a schematic diagram of another embodiment of a camera display 114 with visual feedback to communicate angular movement of the camera system 100 to a user using an updated image position relative to an original image position. In the illustrated embodiment, an initial image marker 132 (shown as solid lines) is shown on the display device 114 to represent at least a portion of the scene at a beginning of the exposure period. Subsequently, a superimposed image marker 134 (shown as dashed lines) is shown on the display device 114 to represent a corresponding portion of the scene at a subsequent time during the exposure period. In this way, the superimposed image marker 134 is superimposed over the initial image marker 132 according to the movement measurement (represented by the arrows) computed by the movement detector 118.

In order to retain some clarity in the displayed image 126 while displaying both the initial image marker 132 and the superimposed image marker 134, it may be helpful make the superimposed image marker 134 at least partially transparent. Additionally, in some embodiments the initial image marker 132 and the superimposed image marker 134 are low resolution images of the scene. For example, where an electronic shutter is implemented, the final image may be formed using a plurality of separate images, or image frames, that are subsequently combined together to form the final image. For each of these image frames, a low resolution version may be displayed (and subsequently removed) so that superimposed image marker 134 appears to move during the exposure time. In another embodiment, the superimposed image marker 124 (and possibly the initial image marker 122) may be mathematically brightened because otherwise the individual image frames may be underexposed and difficult to render on the display device 114. For example, the brightness detector 120 may use contrast equalization to raise the brightness of an image frame to a target brightness. Other image manipulation techniques also may be implemented in addition to, or instead of, changing the resolution and the brightness of the individual image frames.

In an alternative embodiment, the camera system 100 may show a single image frame at a time, without superimposing another image frame. In this embodiment, a low-resolution representation of the image frames may be shown in sequence so that angular hand movements would cause pronounced shifts in the positions of the displayed image scenes. The technique of displaying single images, instead of overlapping images, also may be applied to the embodiments described below which use cropped portions, magnified portions, and thumbnail images.

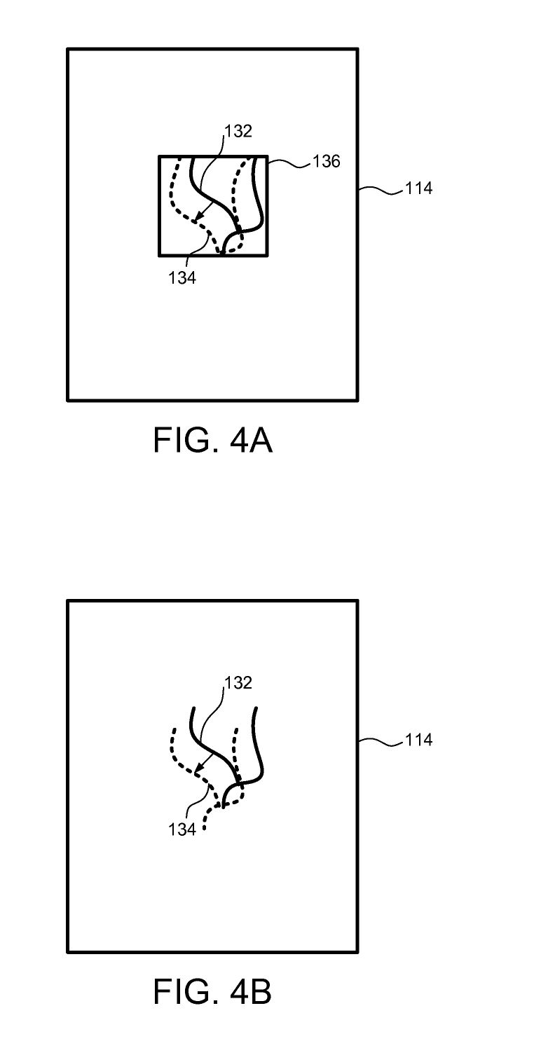

FIG. 4A depicts a schematic diagram of another embodiment of a camera display 114 with visual feedback to communicate angular movement of the camera system 100 to a user using a cropped portion 136 of an image 126. In some embodiments, the initial image marker 132 and the superimposed image marker 134 are both cropped. Alternatively, some embodiments may crop just the superimposed image marker 134 or just the initial image marker 132.

Also, it should be noted that the cropped portions 136 of the initial image marker 132 and the superimposed image marker 134 correspond to the same location of the display device 114, as though they are both viewed through the same window. Thus, if both markers 132 and 134 correspond to the same location of the display device 114, then the cropped portions 136 may show completely different portions of the imaged scene if the position of the camera 100 changes drastically.

Alternatively, the cropped portions 136 of the initial image marker 132 and the superimposed image marker 134 may correspond to a single location of the initial image marker 132, as shown in FIG. 4B. Thus, although both markers 132 and 134 correspond to the same portion of the original image, the superimposed image marker 134 may or may not overlap the initial image marker 132, depending on how much the location of the camera 100 changes during the exposure period.

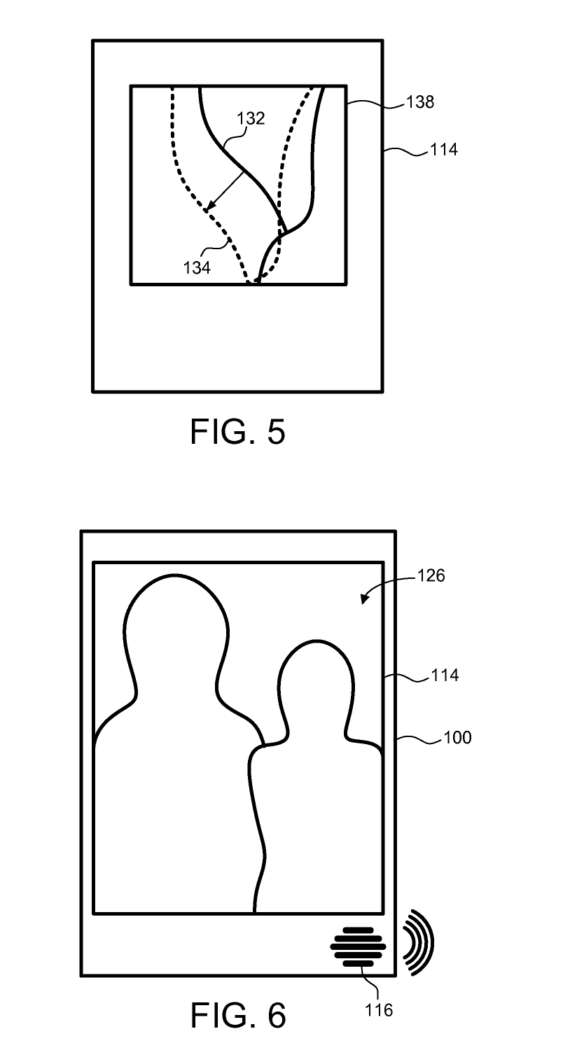

FIG. 5 depicts a schematic diagram of another embodiment of a camera display 114 with visual feedback to communicate angular movement of the camera system 100 to a user using a magnified portion 138 of an image 126. In particular, the magnified portion 138 is at least a portion of the imaged scene, similar to the cropped portion 136 described above. In an alternative embodiment, minified representations such as thumbnail images may be used instead of cropped portions 136 or magnified portions 138.

FIG. 6 depicts a schematic diagram of another embodiment of a camera system 100 with audio feedback to communicate angular movement of the camera system 100 to a user using an audio signal. The illustrated camera system 100 shows a display 114 and an audio circuit 116. As described above, the display 114 may or may not show an image 126 during the exposure period. The audio circuit 116 provides an audio feedback signal to the user based on the movement of the camera 100 during the exposure period. Additionally, in some embodiments the audio feedback may be combined with one or more visual feedback techniques described above.

In one embodiment, the audio circuit 116 generates a variable audio signal. The variable audio signal has a baseline audio characteristic corresponding to the original heading of the image sensor 106. In other words, the baseline audio characteristic is used to indicate the original heading of the image sensor 106 so that the variable audio signal manifests the baseline audio characteristic when the image sensor 106 is directed toward its original heading, either directly or within a threshold. Exemplary baseline audio characteristics include a constant volume or pitch, a consistent frequency of intermittent signals, or any other audio characteristic that produces a change that is perceptible by a user.

As the image sensor 106 deviates from its original heading, the audio circuit 116 varies the baseline audio characteristic according to the movement measurement computed by the movement detector 118. In some embodiments, the baseline audio characteristic varies approximately in proportion, or in relation, to the magnitude of the deviation. As one example, the variable audio signal may vary in volume (e.g., an increase in volume) as the movement measurement deviates from the original heading of the image sensor 106. As another example, the variable audio signal may vary in pitch (e.g., an increase in pitch) as the movement measurement deviates from the original heading of the image sensor 106. As another example, the baseline audio characteristic of the variable audio feedback signal may be a series of intermittent audio signals (e.g., beeps, chirps, etc.), and the audio circuit 116 may vary the frequency of the intermittent audio signals approximately in relation to the magnitude of the movement measurement. Other embodiments may vary other baseline audio characteristics or a combination of baseline audio characteristics.

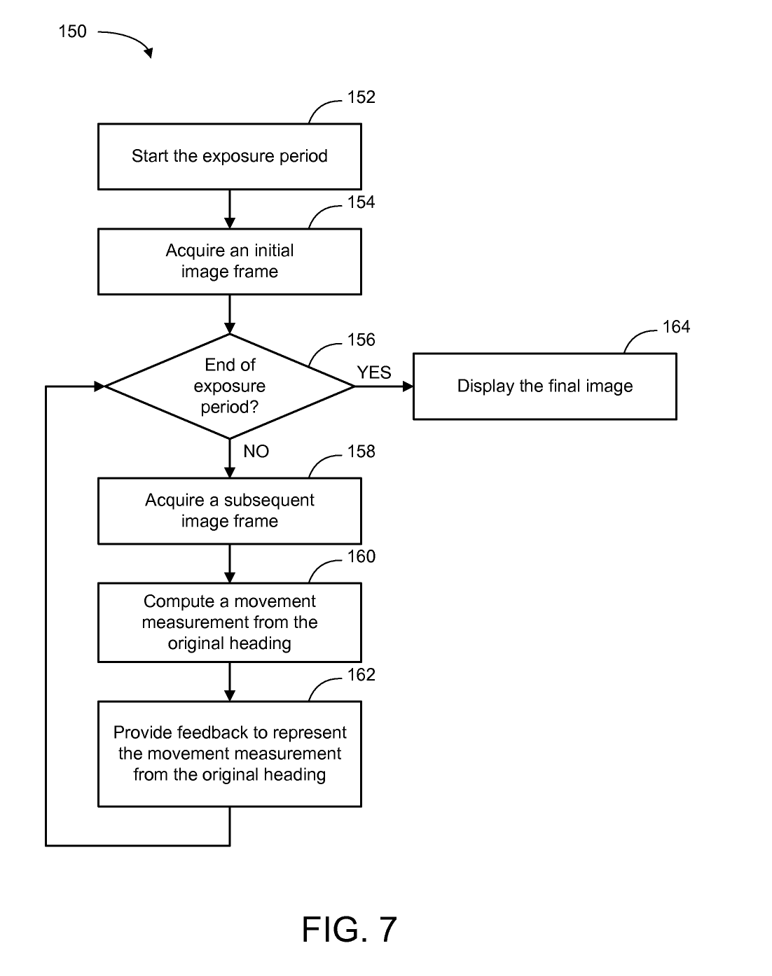

FIG. 7 depicts a schematic flow chart diagram of one embodiment of a method 150 for image stabilization with user feedback. In one embodiment, the method 150 is implemented in conjunction with the camera system 100 of FIG. 1. Alternatively, some embodiments of the method 150 may be implemented with other types of camera systems.

In general, the method 150 for image stabilization includes generating an image of a scene over an exposure period, computing a movement measurement of an image sensor during the exposure period, and providing feedback to a user during the exposure period. In one embodiment, the feedback is indicative of a magnitude of the movement measurement. More specific details of an embodiment of the method 150 for image stabilization are provided below.

At block 152, the camera system 100 starts the exposure period. In one embodiment, the shutter controller 112 opens the shutter 110, either physically or electronically, at the commencement of the exposure period. In some embodiments, the exposure period has a predetermined duration. The predetermined duration of the exposure period may be based on lighting conditions, user selections, shutter speed tables, and so forth. Each image, or picture, taken by the camera system 100 may have a unique shutter speed (i.e., how fast the shutter 110 opens and closes, or how long the image sensor 106 is responsive) that is predetermined before the shutter 110 is opened to capture a particular image. In some embodiments, implementation of the image stabilization techniques described herein may be limited to exposure periods longer than a predetermined time. For example, some embodiments may selectively limit the use of visual and/or audio feedback to exposure periods of approximately one second or longer.

At block 154, the image sensor 106 acquires an initial image frame. Although the method 150 is described using multiple image frames to make up the final image 126, other embodiments may generate a single image over the exposure period. After acquiring the initial image frame, at block 156 the digital processor 102 determines if the exposure period has ended. Alternatively, the image sensor 106 may determine if the exposure period has ended.

If the exposure period has not ended, then at block 158 the image sensor 106 acquires a subsequent image frame. At block 160, the movement detector 118 also computes a movement measurement from the original heading of the image sensor 106. In one embodiment, the movement detector 118 may compare the initial image frame and the subsequent image frame to compute the movement measurement. As described above, the movement measurement may include a magnitude as well as a direction of the movement of the image sensor 106.

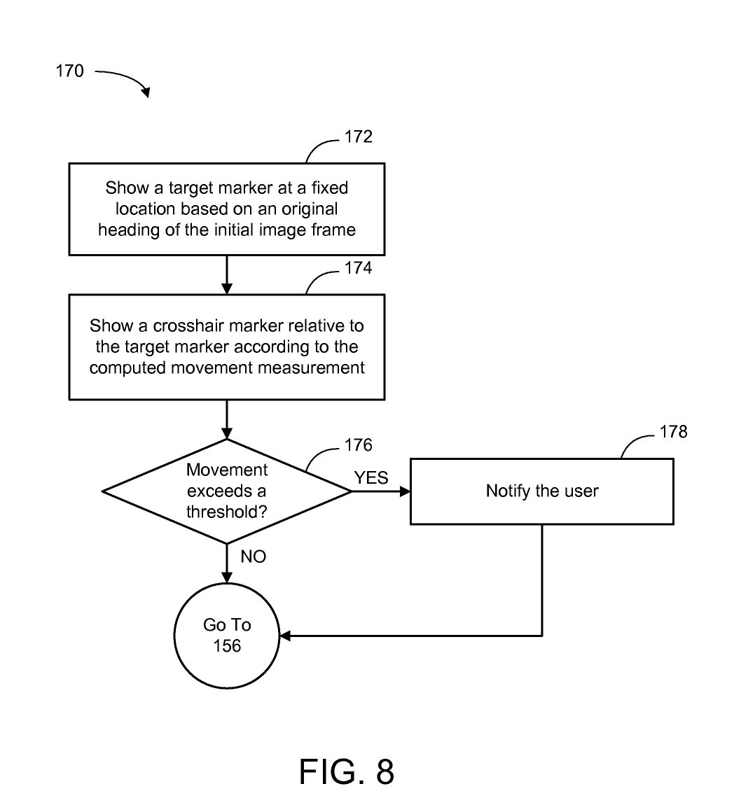

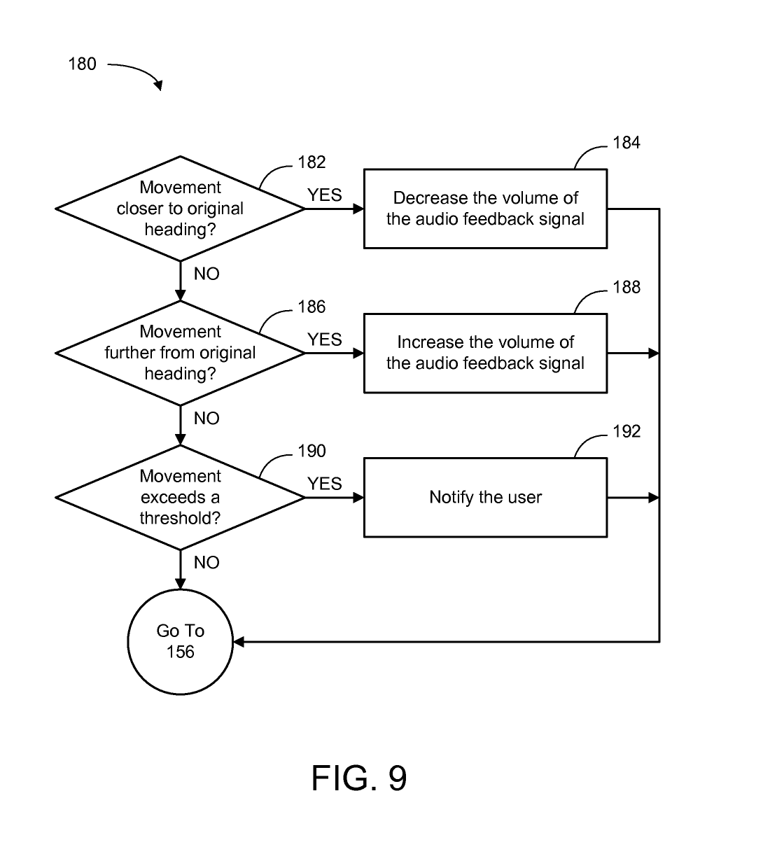

At block 162, the digital processor 102 provides feedback to a user to represent the movement measurement of the image sensor 106 from its original heading. As described above, the feedback may be visual feedback, audio feedback, or a combination of visual and audio feedback. Exemplary embodiments of methods for providing visual and audio feedback are described in more detail with reference to FIGS. 8 and 9, respectively. Once the exposure period ends, at block 164 the display device 114 displays the final image. The depicted method 150 for image stabilization then ends.

FIG. 8 depicts a schematic flow chart diagram of one embodiment of a method 170 for providing visual feedback to a user. In one embodiment, the method 170 is implemented in conjunction with the camera system 100 of FIG. 1. Alternatively, some embodiments of the method 170 may be implemented with other types of camera systems.

At block 172, the display device 114 shows a target marker 122 at a fixed location based on an original heading of the initial image frame. At block 174, the display device 114 shows a crosshair marker 124 relative to the target marker 122 according to the computed movement measurement. Thus, the method 170 illustrates some of the operations that may be used to implement the visual feedback described above with reference to FIGS. 2A and 2B. Other embodiments may implement other forms of visual user feedback.

Additionally, at block 176 the movement detector 118 determines if a movement measurement exceeds a threshold. In one embodiment, the magnitude of the movement measurement is compared to the threshold value. If the movement measurement does exceed the threshold, then at block 178 the camera system 100 may provide additional notification to the user. After providing the additional notification to the user, or if the movement measurement does not exceed the threshold, then the method 170 returns to the operation 156 of FIG. 7 described above.

FIG. 9 depicts a schematic flow chart diagram of one embodiment of a method 180 for providing audio feedback to a user. In one embodiment, the method 180 is implemented in conjunction with the camera system 100 of FIG. 1. Alternatively, some embodiments of the method 180 may be implemented with other types of camera systems.

At block 182, the movement detector 118 determines if the current heading of the image sensor 106 is moving closer to the original heading of the image sensor 106. If so, then at block 184 the audio circuit 116 decreases the volume of the audio feedback signal. Otherwise, at block 186 the movement detector 118 determines if the current heading of the image sensor 106 is moving further from the original heading of the image sensor 106. If so, then at block 188 the audio circuit 116 increases the volume of the audio feedback signal. This increased volume indicates to the user that the final image is possibly going to be more blurry due to the movement of the camera 100. Other embodiments may implement other forms of audio user feedback.

Additionally, at block 190 the movement detector 118 determines if a movement measurement exceeds a threshold. In one embodiment, the magnitude of the movement measurement is compared to the threshold value. If the movement measurement does exceed the threshold, then at block 192 the camera system 100 may provide additional notification to the user. After providing the additional notification to the user, or if the movement measurement does not exceed the threshold, then the method 180 returns to the operation 156 of FIG. 7 described above.

It should be noted that embodiments of the camera system 100 and similar camera systems may be implemented in a variety of imaging applications. For example, embodiments of the camera system 100 may be used in digital still cameras, mobile phone cameras, single lens reflex (SLR) cameras, and so forth. Additionally, embodiments of the camera system 100 may be operated by a human or by an automated operator. For example, a human may operate a camera system integrated into a cell phone. Alternatively, an automated operator may operate a camera system used for security cameras in high vibration environments.

Some embodiments of the camera system 100 provide increased performance compared to conventional camera systems. For example, some embodiments provide a better signal-to-noise ration (SNR). Additionally, some embodiments help a user to maintain image blur at acceptable levels despite unfavorable operating conditions.

Embodiments of the invention also may involve a number of functions to be performed by a computer processor such as a central processing unit (CPU), a microprocessor, or another type of general-purpose or application-specific processor. The microprocessor may be a specialized or dedicated microprocessor that is configured to perform particular tasks by executing machine-readable software code that defines the particular tasks. The microprocessor also may be configured to operate and communicate with other devices such as direct memory access modules, memory storage devices, Internet related hardware, and other devices that relate to the transmission of data. The software code may be configured using software formats such as Java, C++, XML (Extensible Mark-up Language) and other languages that may be used to define functions that relate to operations of devices required to carry out the functional operations related described herein. The code may be written in different forms and styles, many of which are known to those skilled in the art. Different code formats, code configurations, styles and forms of software programs and other means of configuring code to define the operations of a microprocessor may be implemented.

Within the different types of processors that utilize embodiments of invention, there exist different types of memory devices for storing and retrieving information while performing some or all of the functions described herein. In some embodiments, the memory/storage device where data is stored may be a separate device that is external to the processor, or may be configured in a monolithic device, where the memory or storage device is located on the same integrated circuit, such as components connected on a single substrate. Cache memory devices are often included in computers for use by the processor as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform certain functions when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. Embodiments may be implemented with various memory and storage devices, as well as any commonly used protocol for storing and retrieving information to and from these memory devices respectively. In particular, a computer readable storage medium embodying a program of machine-readable instructions, executable by a digital processor, may perform one or more operations of an embodiment of the invention.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus to facilitate image stabilization, the apparatus comprising:
an image sensor to acquire an image of a scene over an exposure period;
a movement detector coupled to the image sensor, the movement detector to compute a movement measurement of the image sensor during the exposure period; and
a digital processor coupled to the movement detector, the digital processor to provide feedback to a user during the exposure period, wherein the feedback is based on the movement measurement.

2. The apparatus of claim 1, wherein the feedback comprises visual feedback for display on a display device coupled to the digital processor.

3. The apparatus of claim 2, wherein the visual feedback comprises:
a first visual marker at a fixed location on the display device, the fixed location corresponding to an original heading of the image sensor; and
a second visual marker moveable on the display device relative to the first visual marker according to the movement measurement computed by the movement detector.

4. The apparatus of claim 2, wherein the visual feedback comprises:
an initial image marker representative of at least a portion of the scene at a beginning of the exposure period; and
a superimposed image marker representative of a corresponding portion of the scene at a subsequent time during the exposure period, wherein the superimposed image marker is superimposed over the initial image marker according to the movement measurement computed by the movement detector.

5. The apparatus of claim 4, wherein the superimposed image marker comprises a cropped portion of the scene.

6. The apparatus of claim 4, wherein the initial image marker and the superimposed image marker comprise magnified portions of the scene.

7. The apparatus of claim 4, wherein the initial image marker and the superimposed image marker comprise low resolution images of the scene.

8. The apparatus of claim 4, wherein the superimposed image marker comprises a mathematically brightened representation of an underexposed image of the scene.

9. The apparatus of claim 1, wherein the feedback comprises audio feedback for communication to a user via an audio circuit coupled to the digital processor.

10. The apparatus of claim 9, wherein the audio feedback comprises a variable audio signal comprising a baseline audio characteristic corresponding to an original heading of the image sensor, wherein the audio circuit is further configured to vary the baseline audio characteristic according to the movement measurement computed by the movement detector.

11. The apparatus of claim 10, wherein the variable audio signal varies in volume as the movement measurement deviates from the original heading of the image sensor.

12. The apparatus of claim 10, wherein the variable audio signal varies in pitch as the movement measurement deviates from the original heading of the image sensor.

13. The apparatus of claim 1, wherein the apparatus comprises a still picture camera of a mobile computing device.

14. A method for image stabilization, the method comprising:
generating an image of a scene over an exposure period;
computing a movement measurement of an image sensor during the exposure period; and
providing feedback to a user during the exposure period, the feedback indicative of a magnitude of the movement measurement.

15. The method of claim 14, wherein providing the feedback to the user further comprises:
showing a first visual marker at a fixed location on the display device, the fixed location corresponding to an original heading of the image sensor; and
showing a second visual marker superimposed in front of the first visual marker on the display device, wherein a distance between the first and second visual markers represents a magnitude and a direction of the movement measurement from the original heading of the image sensor.

16. The method of claim 14, wherein providing the feedback to the user further comprises varying an audio characteristic of a variable audio feedback signal approximately in relation to the magnitude of the movement measurement.

17. The method of claim 16, wherein varying the audio characteristic of the variable audio feedback signal further comprises:
generating a series of intermittent audio signals; and
varying a frequency of the intermittent audio signals approximately in relation to the magnitude of the movement measurement.

18. A camera system with image stabilization, the camera system comprising:
means for computing movement measurement information during an exposure period of an image sensor, the movement measurement information indicative of a movement of the image sensor; and
means for providing feedback to a user during the exposure period, the feedback indicative of a magnitude of the movement measurement of the image sensor.

19. The camera system of claim 18, wherein the means for providing the feedback to the user further comprises means for generating visual feedback for display on a display device, wherein the visual feedback corresponds to the magnitude and a direction of the movement of the image sensor.

20. The camera system of claim 18, wherein the means for providing the feedback to the user further comprises means for generating audio feedback for display on a display device, wherein the audio feedback corresponds to the magnitude of the movement of the image sensor.
